(19) United States
(12) Patent Application Publication
(10) Pub. No.: US 2006/0213627 A1
(43) Pub. Date: Sep. 28, 2006

(54) Slat for a blind

(75) Inventors: Ming Nien, Taichung (TW); Gina I-Chen Chi, Taichung (TW)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 11/086,374

(22) Filed: Mar. 23, 2005

(51) Int. Cl. E06B 3/12

(52) U.S. Cl. 160/236

(57) ABSTRACT

A slat for a blind is to be arranged in a plurality in a hollow of a frame of a blind. And at least one of the plural slats is composed of two wooden boards that are respectively provided with a hollow to face each other, and an intermediate layer is sandwiched between the two wooden boards in the hollows. Then the intermediate layer may be made of cloth, unwoven cloth, colored glass, long woven material or the like admitting varying amounts of light. Thus, the intermediate layer can be exposed in the hollows not hidden by the wooden boards, making the blind looking neat and pretty.

### BACKGROUND OF THE INVENTION

1. Field of the Invention

This invention relates to a blind slat, particularly to one provided with two wooden boards respectively provided with a hollow, and an intermediate layer is laid in the hollow for some light to percolated through, having a beautiful configuration and light percolation

2. Description of the Prior Art

A blind generally is made of wooden, having a frame with an interior hollow for arranging plural slats therein, and the slats have two ends pivotally connected with the frame so as to enable the slats adjusted in their angles to shut or open to different degrees for light to shine through or to be hampered.

However, blind slats are made of wood, impossible to change their shape, looking like very monotonous and devoid of beauty feeling. Further, when the slats are completely adjusted to close up, light is shut off a room. When the slats are adjusted to open, insects or miscellaneous matters may enter and cool outer air may blow in.

### SUMMARY OF THE INVENTION

This invention has been devised to offer a slat for a blind that has a frame with a hollow, and a plurality of the slats are arranged in the hollow and pivotally connected with the two sides of the frame. At least one of the slats is made of two wooden boards both provided with a hollow and an intermediate layer sandwiched between the two wooden boards to close up the hollow of the two wooden boards so that the intermediate layer may expose in the hollows, not hidden by the wooden boards. The intermediate layer is made of cloth, unwoven cloth, colored glass, woven material or the like possible to let light pass through in various amounts.

The slat for a blind according to the invention can change the banal appearance of the conventional bind, upgrading the beauty, especially with the intermediate layer made of various materials being optional for achieving desirable luminance for a room and also hiding function of preventing insects or the like from entering, and cool wind from blowing in.

### BRIEF DECRIPTIOF OF DRAWINGS

This invention will be better understood by referring to the accompanying drawings, wherein;

FIG. 1 is a perspective view of an arch-shape bind with slats in the present invention;

FIG. 2 is a partial exploded perspective view of the blind shown in FIG. 2;

FIG. 3 is an exploded perspective view of the slat for a blind in the present invention;

FIG. 4 is a cross-sectional view of the slat for a blind in the present invention; and,

FIG. 5 is a perspective view of a rectangular blind with the slats in the present invention.

### DETAILED DESCRIPTION OF THE PREFERRED EMBODIMENT

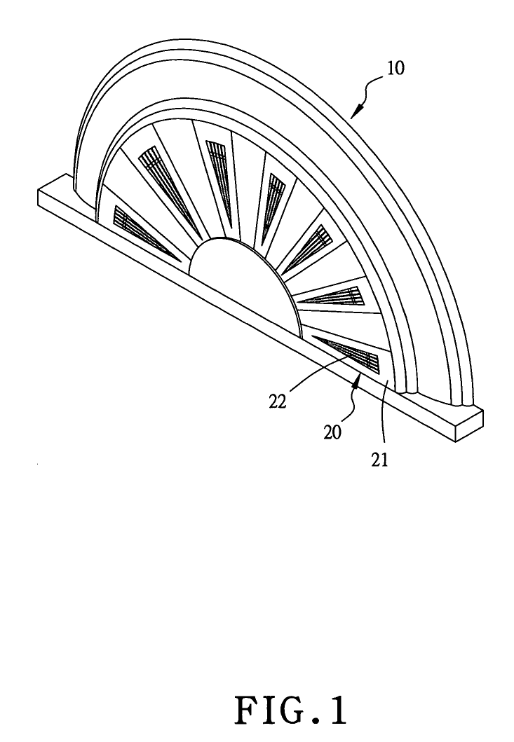

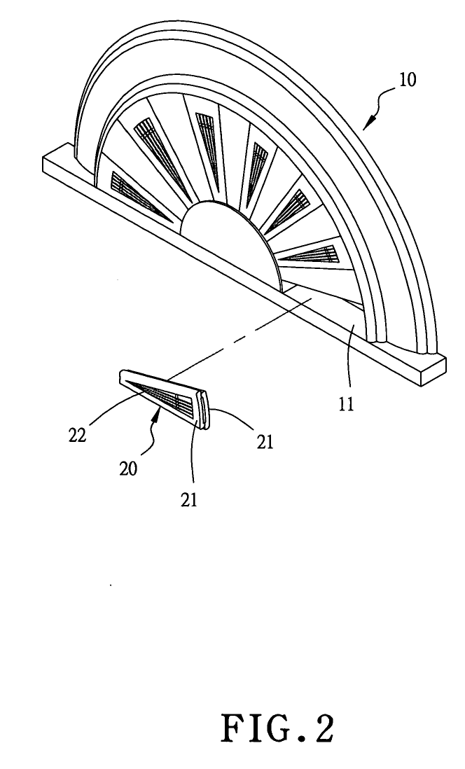

A preferred embodiment of a blind slat in the present invention, as shown in FIGS. 1 and 2, for an example, is used in an arch-shaped blind that has a semicircular wooden frame 10, an hollow 11 in the frame 10, and plural wooden slats 20 of a fan shape in the invention positioned in the hollow 11. Then each slat 20 has two ends pivotally connected with the two sides of the frame 10 to enable each slat to be rotated and adjusted in the angle to open or close in various degrees for shutting out or permitting light to pass through in various amounts

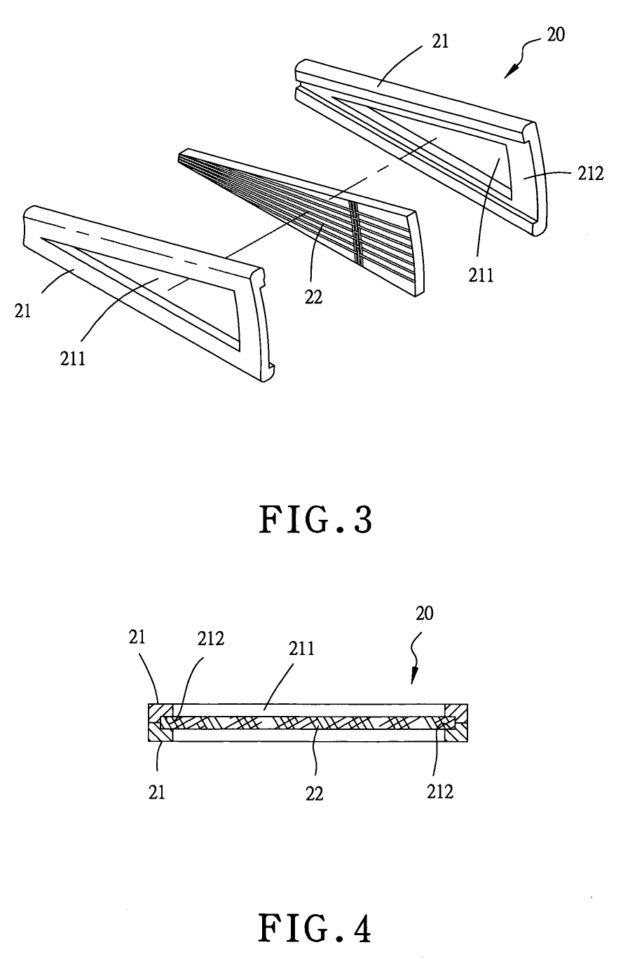

The slat 20 is composed of two wooden boards 21, and an intermediate layer 22, as shown in FIGS. 3 and 4. Each wooden board 21 has a fan-shaped hollow 211 and a position recess 212 formed in the inside wall surrounding the hollow 211. The intermediate layer 22 is sandwiched in the position recess 212 of the two wooden boards 21, secured stably and exposed in the hollows 211 after the two wooden boards 21 are glued together. The intermediate layer 22 can be made of cloth, unwoven cloth, colored glass, a woven strip or the like having a property to let light pass through in various amounts so as to give various luminance to a room.

In this embodiment, the intermediate layers 22 are laid alternately in the plural slats 20 laid in a blind, not in all of the slats 20.

Further, in order to clearly understand the structural characteristics and application of the slat for a blind in the invention, how to use it is to be described below.

Referring to FIG. 1, the slats 20 used in the arch-shaped blind have two ends pivotally connected with the two sides of the frame to be rotatably adjusted in the angle, so they are possible to be opened or closed in various degrees according to different needs for ventilation or shading light. It is to be specially mentioned that each slat 20 has the intermediate layer 22 sandwiched and located to fill up the hollows 211 of each slat, made of cloth, unwoven cloth, colored glass, woven strips or the like for light to pass through in various amounts. Therefore, when the slats are adjusted to close up, exterior light may pass through the intermediate layer 22 properly into a room for lighting the room in some degree not completely shut out. So various materials can be optional and usable for the intermediate layer 22, depending on the necessity of luminance for a room. Further, the intermediate layer 22 can function as an obstacle for preventing insects or the like and cool winds from entering

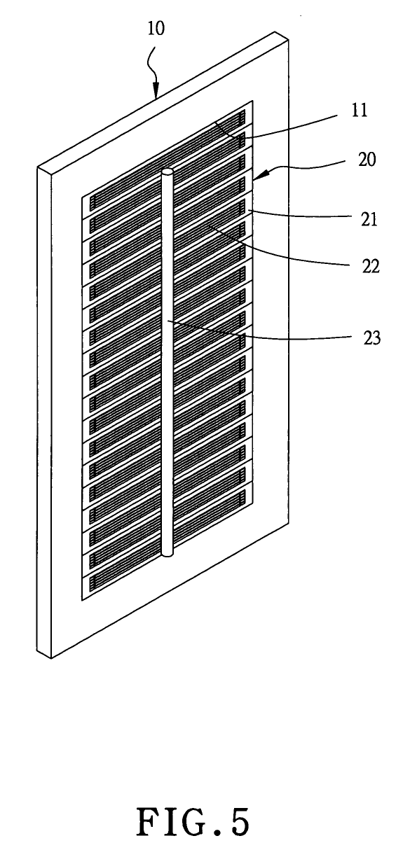

Next, as shown in FIG. 5, the slat 20 is applied to a rectangular blind, which has a similar structure of the arch-shaped blind, only different in the shape. The frame 10 of the rectangular blind is rectangular, having a rectangular hollow 11, in which the slats 20 are horizontally arranged, having two ends pivotally connected with two sides of the frame 10, and an operational rod 23 is fixed vertically on the middle point of all the slats 20 so that the operational rod 23 can be handled to move the slats 20 together to pivotally rotate to change their angle for opening or closing the blind for various degrees to shut out or permit light to pass through accordingly.

As can be seen from the foresaid description, the slat for a blind in the invention has the following advantages.

1. The intermediate layer 22 sandwiched between the two wooden boards 21 and filling the hollows 211 can make the whole blind look neat and pretty, improving banal monotony of the conventional blind.

2. The intermediate layers 22 in the slats can still admit light to pass through in various amounts to give some luminance to a room, even if the slats are adjusted to close up, and also possible to prevent insects or the like and cool winds from entering.

3. A user can select the material of the intermediate layers 22 for obtaining right luminance for meeting the necessity.

4. The slats 20 can be changed solely, without need to change the frame of a conventional blind, easily applicable to the existent frame of a blind so as to save some expenditure in refurbishing a conventional blind.

While the preferred embodiment of the invention has been described above, it will be recognized and understood that various modifications may made therein and the appended claims are intended to cover all such modifications that may fall within the spirit and scope of the invention.

What is claimed is:

1. A slat for a blind, said blind having a preset shaped frame, said frame having a hollow for arranging a plurality of said slats therein, said slats respectively having two ends pivotally connected with said frame for changing their angles: and
At least one of said slats having a hollow of a preset shape, an intermediate layer positioned in said hollow.

2. The slat for a blind as claimed in claim 1, wherein said slat is composed of two wooden boards, said two wooden boards respectively have a hollow to face each other, said intermediate layer is sandwiched between said two wooden boards in such a way that the intermediate layer is exposed in said hollows of said two wooden boards, not hidden.

3. The slat for a blind as claimed in claim 2, wherein said two wooden boards further respectively have a position recess in an area surrounding said hollow for said intermediate layer to be received therein.

4. The slat for a blind as claimed in claim 2, wherein said two wooden boards are glued together stably

5. The slat for a blind as claimed in claim 1, wherein said intermediate layer is made of cloth.

6. The slat for a blind as claimed in claim 1, wherein said intermediate layer is made of unwoven cloth.

7. The slat for a blind as claimed in claim 1 wherein said intermediate layer is made of glass.

8. The slat for a blind as claimed in claim 1 wherein said intermediate layer is made of woven material of a long strip shape.
